(19) United States
(12) Patent Application Publication
(10) Pub. No.: US 2010/0210453 A1
(43) Pub. Date: Aug. 19, 2010

(54) Preparation Of Nanostructured Metals And Metal Compounds And Their Uses

(75) Inventors: Yong-Sheng Hu, Stuttgart (DE); Yu-Guo Guo, Stuttgart (DE); Palani Balaya, Stuttgart (DE); Joachim Maier, Wiernsheim (DE); Sarmimala Hore, Stuttgart (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Max-Planck-Gesellschaft zur Foerderung der Wissenschaften e.V., Muenchen (DE)

(21) Appl. No.: 12/294,866

(22) PCT Filed: Mar. 29, 2007
(86) PCT No.: PCT/EP2007/002826

§ 371 Date: Apr. 22, 2010

(30) Foreign Application Priority Data
Mar. 29, 2006 (EP) 06006529.9

(51) Int. Cl. B01J 23/40; C25B 1/00; B01J 21/18; B01J 23/50

(52) U.S. Cl. 502/184; 205/477; 205/483; 205/488; 205/491; 205/494; 205/506; 205/507; 205/615; 502/185; 977/700

(57) ABSTRACT

A method for the preparation of materials comprises the steps of: a) taking a first material comprising a compound of a first metal or of a first metal alloy, b) inserting said first material into an electrochemical cell as a first electrode, the electrochemical cell including a second electrode including a second metal different from a metal incorporated in the first material and an electrolyte adapted to transport the second metal to the first electrode and insert it into the first material by a current flowing in an external circuit resulting in the formation of a compound of the second metal in the first electrode material, the method being characterized by the step of treating the first electrode material after formation of the compound of the second metal to chemically remove at least some of the compound of the second metal to leave a material with a nanoporous structure.

The present invention relates to a method for the preparation of nanostructured metals and metal compounds and to their uses.

Nanostructured materials have attracted great technological interest during the past two decades essentially due to their wide range of applications: they are used as catalysts, molecular sieves, separators or gas sensors as well as for electronic and electrochemical devices. Most syntheses of nanostructured materials reported so far focused on template-assisted bottom-up processes including soft templating (chelating agents, surfactants, block copolymers, etc.) and hard templating (porous alumina, carbon nanotubes, and nanoporous materials) methods or solution-based methods with appropriate organic additives.

The principal objects of the present invention are to provide a room temperature method of wide applicability for the synthesis of nanostructured metals or metal compounds with large surface area and pronounced nanoporosity. The method should also be a template-free method which does not involve surfactants. Furthermore, the method should preferably be capable of further development to allow the production of nanoparticles. In addition the invention is directed to specific uses of the products of the methods in accordance with the present invention.

In order to satisfy these objects method-wise there is provided a generally applicable method for the preparation of materials comprising the steps of:
a) taking a first material comprising a compound of a first metal or of a first metal alloy,
b) inserting said first material into an electrochemical cell as a first electrode, the electrochemical cell including a second electrode comprising a second metal different from a metal incorporated in the first material and an electrolyte adapted to transport the second metal to the first electrode and insert it into the first material by a current flowing in an external circuit, thus resulting in the formation of a compound of the second metal in the first electrode material, and
c) treating the first electrode material after formation of the compound of the second metal to chemically and/or electrochemically remove at least some of the compound of the second metal to leave a material with a nanoporous structure.

The initial insertion of a (second) metal in the form of lithium into an electrode material comprising a compound of a (first) metal in the form of CoO is known in connection with the conversion reaction in lithium ion batteries from the article “Nano-sized transition-metal oxides as negative—electrode materials for lithium-ion batteries” by P. Poizot, S. Laruelle, S. Grugeon, L. Dupont and J-M. Tarascon published in Nature Vol. 407, 28 September 2000 on pages 496 to 499. That article, which is restricted to the field of lithium-ion batteries, recognised that when CoO particles are used as an electrode in a lithium ion battery with the other electrode incorporating lithium the reaction

CoO+2Li⁺+2e⁻→Co+Li₂O (1)

takes place.

The present invention builds on this prior art by recognising that it is possible to obtain nanoporous material in the form of a nanoporous metal or of a nanoporous metal compound or nanoporous mixture of a metal and metal compound by treating the first electrode material after formation of the compound of the second metal to chemically remove or leach out at least some of the compound of the second metal to leave a material with a nanoporous structure. Moreover, the method is not restricted to the metal Co but is of general applicability to a wide range of metals derived from metal compounds such as MpX, where Mp designates a first “parent” metal selected from the group comprising Pt, Ru, Au, Ir, Ti, V, Cr, Mn, Fe, Co, Ni, Cu, Zn, Zr, Nb, Mo, Rh, Pd, Ag, Cd, In, Sn, Sb, Hf, Ta, W, Re, Os, Tl, Pb and Bi as well as alloys thereof, and X includes compounds selected from the group comprising oxides, sulfides, fluorides, chlorides, nitrides and phosphides.

In carrying out the method the second metal is preferably selected from the group including Li, Na, K, Cs, Mg, Ca and Al.

One basic possibility of chemically removing at least some of the compound of the second metal is to immerse the first selected material after formation of the compound of the second metal in a solvent to chemically remove the second metal compound by dissolving it in or reacting it with at least one of the following chemicals: water, dilute sulphuric acid, 0.1 to 1.0 molar sulphuric acid, concentrated sulphuric acid, 0.1 to 1.0 molar HCl, and HN0₃, with the chemical being selected so that it can dissolve the compound of the second metal but does not chemically react with the first metal or first metal compound. Thus a straightforward chemical treatment of the first electrode material, after treatment of the same in an electrochemical cell to insert the second metal into it and convert at least some of the compound of the first metal or first metal alloy to a compound of the second metal, makes it possible to produce nanoporous material. The nanoporous material so produced is present in the form of the first metal, or of the first metal alloy or in the form of a mixture of the first metal or metal alloy with a compound thereof, which results when not all the second metal compound is chemically removed. This production of the nanoporous material is achieved without the use of any template or surfactant.

In accordance with another basic possibility the direction of current flow in the electrochemical cell is reversed, prior to carrying out the step c), to at least partially reduce the second metal compound to the second metal and at least partially remove the second metal from the first electrode material.

This variant of the method reflects the fact that the nanoporous material is generated during the insertion of the second metal into the material of the first electrode during the discharging cycle of the cell and that the nanoporous morphology is thereafter preserved even when the second metal is removed again by discharging the cell. In the field of lithium batteries it is conventional to define the insertion reaction by which lithium is incorporated into another active material by a current flowing in an external circuits as a discharging reaction and the extraction of lithium from this active material by an external current supply reversing the current polarity as a charging reaction.

When this mode of operation is selected it is generally difficult to remove all the inserted second metal from the material of the first electrode so that the nanoporous material which results is generally a mixture of a first metal or metal alloy and a compound thereof.

In a preferred variant of this method the step of reversing the direction of current flowing in the electrochemical cell is effected until a maximum potential difference is achieved between the first electrode and the second electrode typical for the second metal prior to degradation of the electrolyte.

E.g. the maximum potential difference is 4.3 volts (with respect to Li⁺/Li) for lithium and 4.0 volts (with respect to Na⁺/Na) for Na.

The nanoporous material prepared by the method can be a compound of a first metal and a first metal which is present in the form of a porous nanostructure. Such a nanoporous material can be achieved by reversing the direction of the current for a period of time such that only some but not all of the second metal is removed from the first material to leave a mixture of the first metal and of the compound of the first metal and of the compound of the second metal. This residual compound of the second metal can then be removed chemically by a washing or leaching step to leave a mixture of the first metal and of the compound of the first metal with both in nanoporous form.

Irrespective of whether the nanoporous material is obtained from the first electrode material only by treating it chemically or by treating it electrochemically after a charging process in the electrochemical cell, it is possible to convert the nanoporous material into nanoparticles by exposing the nanostructure to an energy field such as an ultrasonic field.

The first material is preferably selected in the form of particles having a size in the range from 50 μm to 100 nm, preferably in the range from 5 μm to 200 nm and especially in the range from 1 μm to 300 nm. After step c), the material having a nanoporous structure includes particles having the same morphology, i.e. essentially the same shape or envelope as the original particles but with the nanoporous structure, i.e. typically with particle and pore sizes in the range from 2 nm to 50 nm.

The first electrode preferably comprises a powder mixed with a binder and applied to a substrate, in particular to a substrate comprising a metallic foil or mesh selected from the group comprising Cu, Ti, Ni and stainless steel.

The first material can also be prepared as a mixture of a compound of a first metal or of a first metal alloy with one or more other conductive powders, e.g. carbon black and/or graphite.

One possibility for realising the first electrode is to place the particles of the first material as a layer on a base of a tray or hollow vessel which is disposed with its base substantially horizontal in the electrolytic cell.

Another possibility is to bond the particles of the first material together and to a porous conductive carrier using one or more binders.

The first material can also be present in the form of a film or of particles bound together by a binder to form a film.

Alternatively the first material can comprise one or more pellets formed from a mixture of a powder and a binder and such pellets can be placed on the base of a tray as mentioned above.

It has also surprisingly been found that the method of the invention can also be extended to the manufacture of nanoporous carbon. Thus, also in accordance with the present invention, there is provided a method for the preparation of nanoporous carbon comprising the steps of:
a) taking a first material (15) comprising a compound of carbon,
b) inserting said first material (15) into an electrochemical cell (10) as a first electrode (14), the electrochemical cell including a second electrode (16) including a metal selected from the group including Li, Na, K, Cs, Mg, Ca and Al an electrolyte (18) adapted to transport the metal to the first electrode and insert it into the first material by a current flowing in an external circuit (20) resulting in the formation of a compound of the second metal in the first electrode material (15) and
c) treating the first electrode material (15) after formation of the compound of the second metal to chemically and/or electrochemically remove at least some of the compound of the second metal to leave carbon material with a nanoporous structure.

The carbon compound is preferably CF_{1.1} or CFₓ (0<x<1.2), the second metal is preferably Li and the electrolyte is preferably 1 M LiPF₆ in EC/DMC (1:1 by volume).

Preferred uses of the nanoporous material produced in accordance with the invention are set forth in the claim 16.

The invention will now be explained in more detail by way of example only and with reference to the accompanying drawings in which:

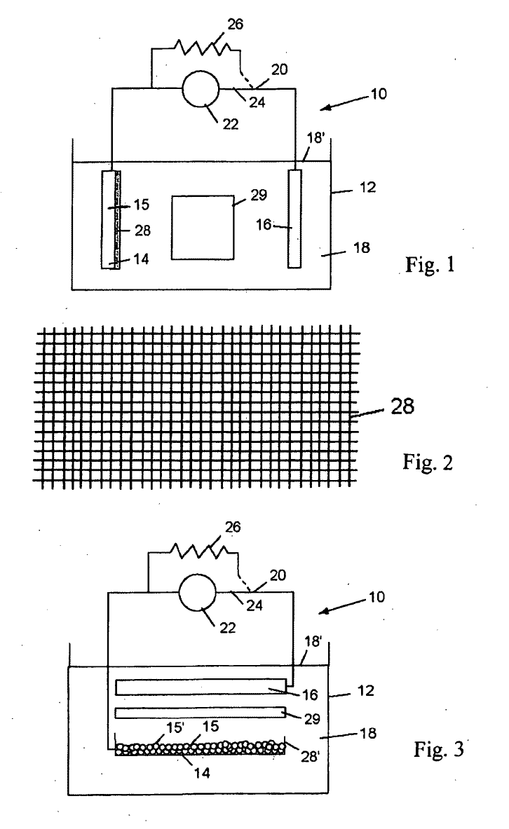

FIG. 1 is a schematic illustration of a first electrochemical cell suitable for use in the method of the present invention,

FIG. 2 is a schematic illustration of a carrier used in a first electrode as used for example in FIG. 1,

FIG. 3 is a schematic illustration of an alternative electrochemical cell suitable for the method of the present invention,

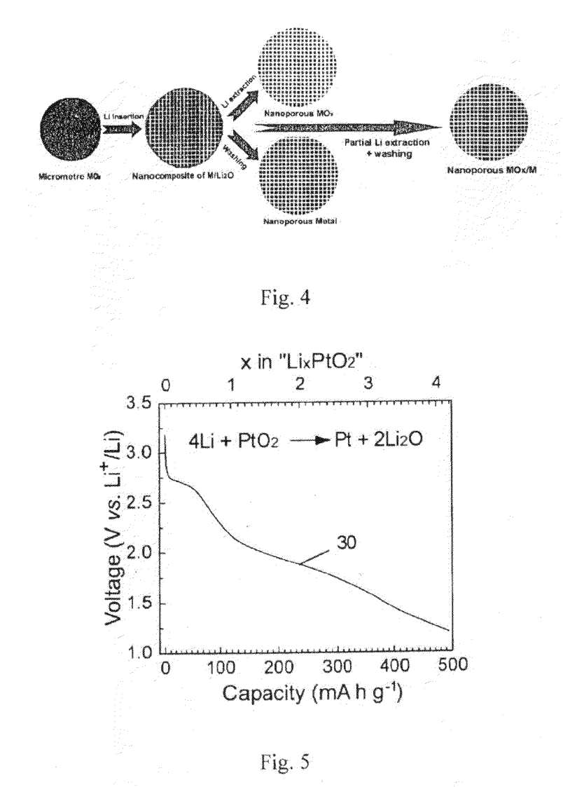

FIG. 4 is a general scheme for the template-free electrochemical lithiation/delithiation synthesis of nanoporous structures,

FIG. 5 shows a discharge curve of a PtO₂ electrode discharged to 1.2 volts,

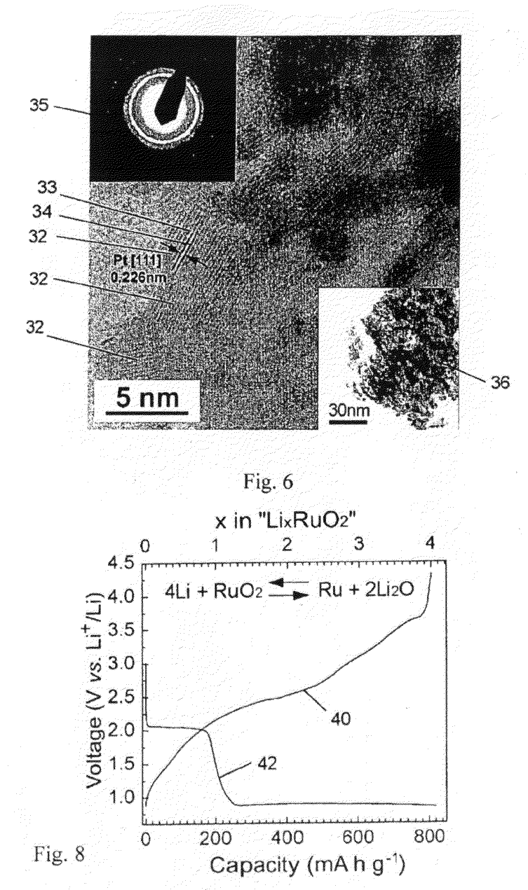

FIG. 6 shows HRTEM images of nanoporous Pt before washing,

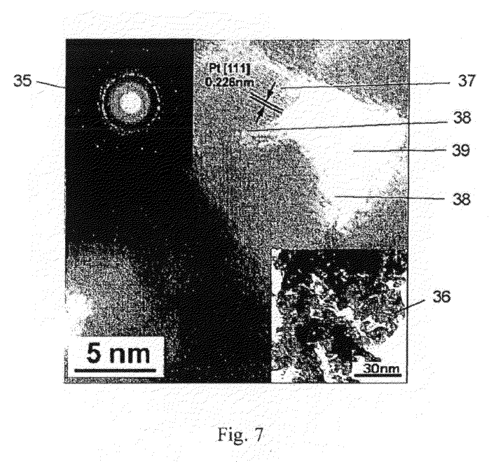

FIG. 7 shows HRTEM images of nanoporous Pt after washing,

FIG. 8 shows discharge and charge curves of an RuO₂ electrode cycled between 0.8 and 4.3 volts

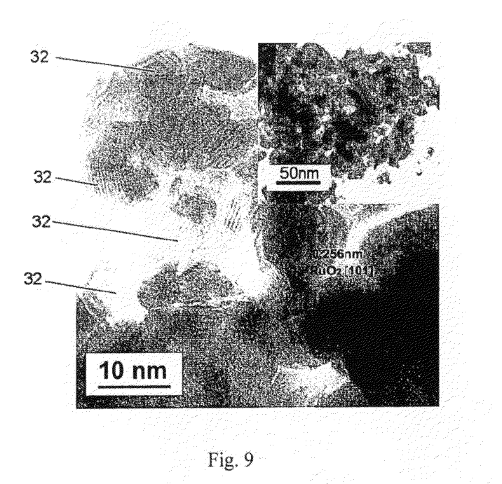

FIG. 9 shows HRTEM images of nanoporous RuO₂ prepared using Li as a second metal,

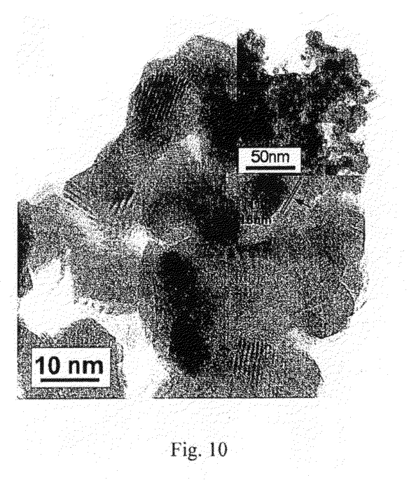

FIG. 10 shows HRTEM images of nanoporous RuO₂ prepared using Li as a second metal and after washing,

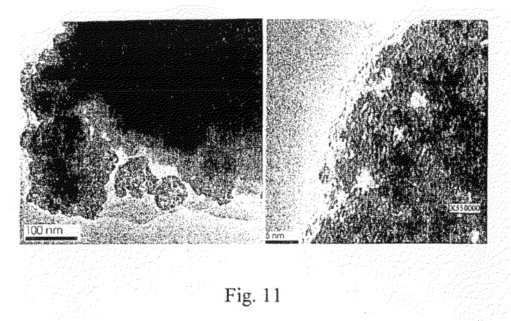

FIG. 11 shows HRTEM images of nanoporous RuO₂ prepared using Na as a second metal,

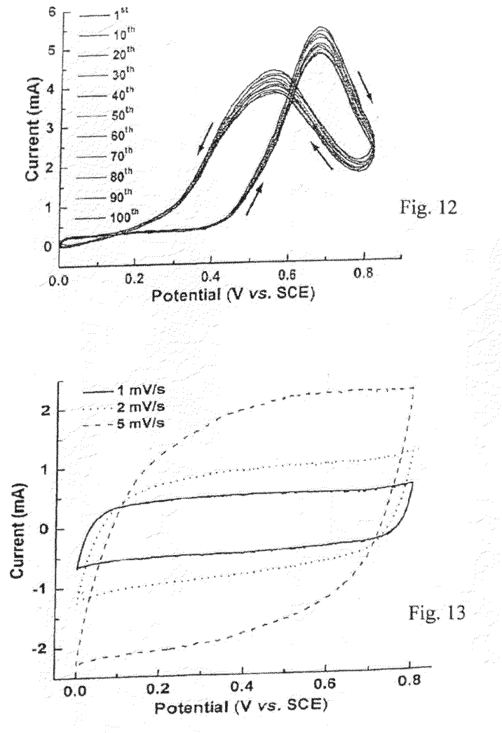

FIG. 12 shows cyclic voltammograms for nanoporous Pt electrode cycled at a scan rate of 20 mV s⁻¹ in 1 M methanol in 0.5 M H₂SO₄ and

FIG. 13 shows cyclic voltammograms for the nanoporous RuO₂ electrode at different scan rates in 1.0 M H₂SO₄ solution,

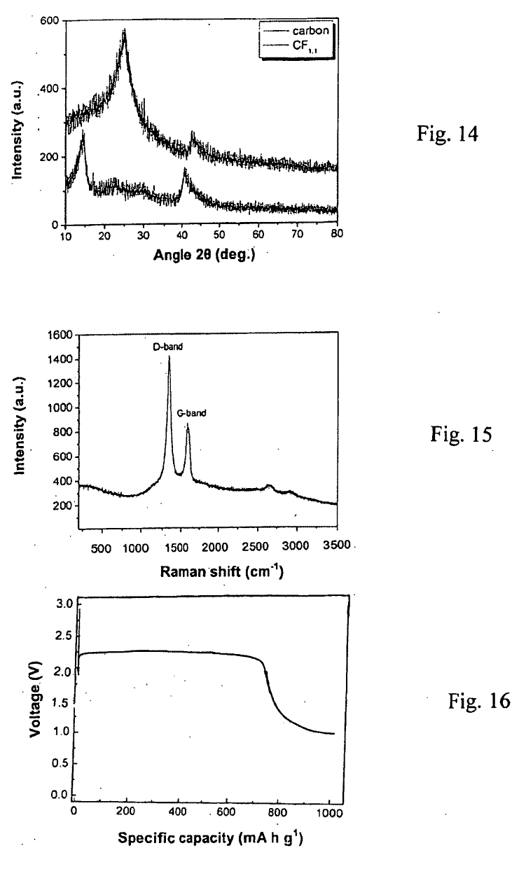

FIG. 14 shows XRD patterns relating to the preparation of nanoporous carbon, namely for the starting material of CF_{1.1} (lower pattern) and of nanoporous carbon (upper pattern),

FIG. 15 shows the Raman spectrum of the prepared nanoporous carbon,

FIG. 16 shows the discharge (Li insertion, voltage decreases) of the CF_{1.1} electrode used in the preparation of nanoporous carbon and discharged to 1.01 V,

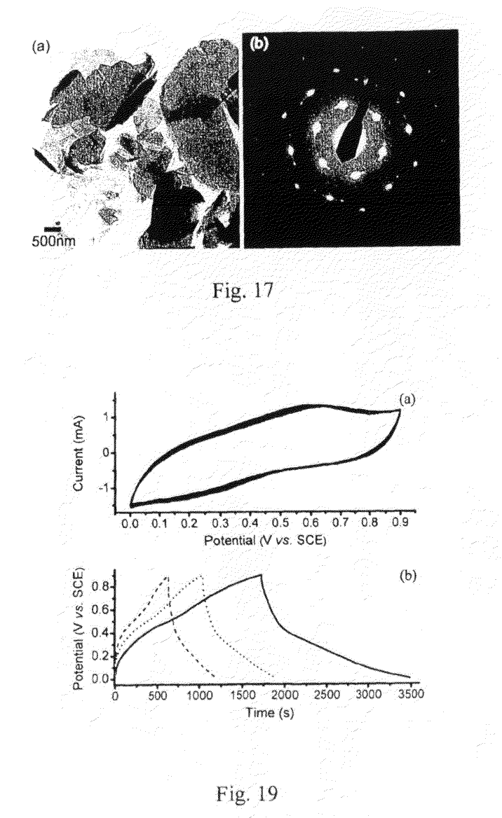

FIG. 17 shows, in (a), a typical TEM image and in (b) SAED pattern of the starting material of CF_{1.1},

FIG. 18 shows in (a) a typical TEM image in (b) and (c) HRTEM images to different scales and in (d) a 3D view of nanoporous carbon (the darker grey areas are the pores, the lighter grey areas are the carbon, and

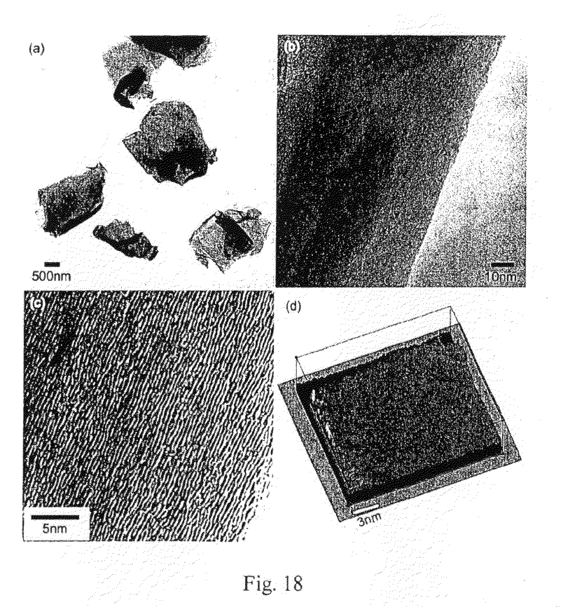

FIG. 19 shows at (a) cyclic voltammograms for the nanoporous carbon electrode at a scan rate of 5 mV s⁻¹ in 1.0 M H₂SO₄ solution and at (b) galvanostatic discharge/charge curves of nanoporous carbon sample cycled at constant currents of 0.2 (solid line) 0.3 (dot line) and 0.4 (dash line) mA, respectively.

Turning first to FIG. 1 there is shown an electrochemical cell 10 comprising a container 12 and in the container a first electrode 14, a second electrode 16 and an electrolyte 18. The first and second electrodes are connected into an external circuit 20 including a power source 22 such as a voltage source or a current source, e.g. a constant voltage source or a constant current source, permitting charging of the electrochemical cell. In addition the external circuit 20 includes a switch 24 which permits a load such as resistor 26 to be connected between the electrodes 14, 16 for discharging of the electrochemical cell.

The electrochemical cell 10 also includes a separator 29 which consists of a porous separator material such as porous polymer, e.g.“celgard”.

In order to carry out the method of the present invention a first material comprising a compound of a first metal or of a first metal alloy is incorporated into the electrochemical cell 10 as the first electrode 14. The second electrode 16 includes a second metal different from the first and which should preferably be more active chemically than the first metal or metal alloy. All the metals listed herein as a second metal, i.e. Li, Na, K, Cs, Mg, Ca and Al, are chemically more active than all the metals listed herein as a first metal, i.e. Pt, Ru, Au, Ir, Ti, V, Cr, Mn, Fe, Co, Ni, Cu, Zn, Zr, Nb, Mo, Rh, Pd, Ag, Cd, In, Sn, Sb, Hf, Ta, W, Re, Os, Tl, Pb and Bi.

The electrolyte 18 is adapted to transport the second metal to the first electrode and insert it into the first material by a current flowing in the external circuit 20. This results in the formation of a compound of the second metal in the first material, i.e. in the first electrode.

During the insertion of the second metal into the first electrode material and formation of the compound of the second metal the structure of the first material changes from macroparticles of the compound of the first metal or metal alloy of micron size to nanometer size microparticles of the first metal or metal alloy interspersed with nanometer size microparticles of the same compound of the second metal. This conversion reaction usually is accompanied by an increase in the size of the macroparticles which however retain the same general shape or envelope despite the increase in size and despite the fact that they are now made up of microparticles.

Once this method step has been completed and the compound of the second material has been formed the first electrode can be removed from the electrochemical cell and treated to chemically remove at least some of it to leave a material with a nanoporous structure.

The first metal can be selected from the group comprising Pt, Ru, Au, Ir, Ti, V, Cr, Mn, Fe, Co, Ni, Cu, Zn, Zr, Nb, Mo, Rh, Pd, Ag, Cd, In, Sn, Sb, Hf, Ta, W, Re, Os, Tl, Pb and Bi and an alloy of any of the foregoing.

The first material preferably comprises an oxide, sulphide, fluoride, chloride, nitride or phosphide compound of one of the first metals or of an alloy thereof.

The second metal is typically selected from the group including Li, Na, K, Cs, Mg, Ca and Al.

The electrolyte is selected according to the second metal that is to be inserted into the first material. For the insertion of lithium ions the electrolyte can, for example, be any electrolyte used in a lithium ion battery such as an anhydrous electrolyte available from Merck in the form of 1 molar LiPF₆, EC-DMC (1:1). That is to say a mixture of ethylene carbonate and dimethyl carbonate is formed in the ratio 1:1 by weight and the lithium phosphorous fluoride 6 is dissolved in it to a concentration of 1 molar.

Alternatively, for lithium insertion, the electrolyte could be LiClO₄ dissolved to a concentration of 1 molar in a mixture of EC and DMC in the ratio 1:1 by weight.

If the metal to be inserted is Na then the electrolyte can be NaClO₄ dissolved to a concentration of 1 molar in a mixture of EC and DMC in the ratio 1:1 by weight.

If the metal to be inserted is K then the electrolyte can be KClO₄ dissolved to a concentration of 1 molar in a mixture of EC and DMC in the ratio 1:1 by weight.

If the metal to be inserted is Cs then the electrolyte can be CsClO₄ dissolved to a concentration of 1 molar in a mixture of EC and DMC in the ratio 1:1 by weight.

If the metal to be inserted is Mg then the electrolyte can be Mg(ClO₄)₂ dissolved to a concentration of 1 molar in a mixture of EC and DMC in the ratio 1:1 by weight.

If the metal to be inserted is Ca then the electrolyte can be Ca(N(CF₃SO₂)₂)₂ dissolved to a concentration of 1 molar in a mixture of EC and DMC in the ratio 1:1 by weight.

If the metal to be inserted is Al then the electrolyte can be Al(N(CF₃SO₂)₂)₃ dissolved to a concentration of 1 molar in a mixture of EC and DMC in the ratio 1:1 by weight.

There seems to be no special rule with regard to selection of the electrolyte. The only rule is that the electrolyte should include a compound of the metal or metal alloy to be inserted.

Other possible solvents for any of the salts listed above are (without restriction) THF (tetrahydrofuran) or polypropylene carbonate.

These electrolytes are given purely by way of example and are not in any way an exhaustive list of the possible electrolytes.

The treatment of the first selected material after formation of the compound of the second metal to chemically remove at least some of it is conveniently effected by one of the following chemicals: water, dilute sulphuric acid, 0.1 to 1.0 molar sulphuric acid, concentrated sulphuric acid, 0.1 to 1.0 molar HCl, and HNO₃ and is selected so that it can dissolve the compound of the second metal and does not chemically react with the first metal or first metal compound.

In an alternative embodiment, prior to treatment of the first selected material after formation of the compound of the second metal to chemically remove at least some of it, the direction of current flow in the electrochemical cell can be reversed by changing the position of the switch 24 to disconnect the power source 22 from the external circuit thereby allowing the electrochemical cell to charge. This at least partially reduces the second metal compound to the second metal and at least partially removes the second metal from the first electrode material leaving a nanoporous material.

It is noted that some reactions, for example the insertion of lithium into RuO₂ and the extraction of lithium from RuO₂ are fully reversible. If the reaction is fully reversed then the RuO₂ which is obtained is nanoporous and no washing or chemical treatment is necessary to obtain the nanoporous RuO₂.

On the other hand, some other reactions such as the insertion of Na into RuO₂ are not fully reversible so that, after removal of the maximum of say 80% of Na from the first material, the first material comprises RuO₂ plus the remainder of the Na in the form of Na₂O and Ru in metal form. Then the remaining Na₂O can be removed chemically or by washing in a suitable solvent to leave a mixture of RuO₂ and Ru in nanoporous form.

The step of reversing the direction of current flowing in the electrochemical cell is conveniently effected until a maximum potential difference is achieved between the first electrode and the second electrode typical for the second metal prior to degradation of the electrolyte. This maximum potential, which is characteristic for any selected second metal, signifies that the maximum amount of the second metal has been removed from the first electrode material.

The maximum potential difference is 4.3 volts for lithium and 4.0 volts for sodium.

The nanoporous structure which results can consist simply of the first metal (or first metal alloy) or of a mixture of the first metal (or first metal alloy) and a compound of the second metal. This nanoporous structure can then be subjected to an energy field such as an ultrasonic field to split the nanostructure into particles.

The first material is typically selected in the form of particles having a size in the range from 50 μm to 100 nm, preferably in the range from 5 μm to 200 nm and especially in the range from 1 μm to 300 nm and, after step c), the material having a nanoporous structure includes particles having the same morphology, i.e. essentially the same shape or envelope as the original particles (in some cases with an increased size) but with the nanoporous structure.

To make the first electrode 14 the compound of the first metal or first metal alloy in powder form is mixed with a binder and applied to a substrate such as 28 in FIG. 1.

The substrate 28 conveniently comprises a metallic foil or more preferably a mesh 28 such as is shown in FIG. 2, and which is conveniently made of a material selected from the group comprising Cu, Ti, Ni and stainless steel, with Ni being particularly preferred. A mesh has the advantage that it not only provides a good anchorage for and electrical contact to the first material but also ensures the electrolyte has access to the first material from all sides. The mesh can for example be a woven or welded wire mesh with mesh apertures of ca. 0.5 mm. It could also be laser perforated foil

The first material can also be prepared as a mixture of a compound of a first metal of a first metal alloy with one or more other conductive powders such as carbon black and/or graphite. One suitable binder is PVDF. The first material could, for example, be (without restriction) a mixture of the powders of the first metal compound, carbon black and/or graphite and PVDF in the ratio 80:10:10 by weight. This means that if a mixture of carbon black and graphite is used then the total amount of the two materials is 10% by weight of the total, if just one of them is used then the amount used is again 10% by weight of the total. The PVDF is typically dissolved in a solvent such as NMP (N-methyl-2-pyrrolidinone) which is subsequently removed by evaporation. An alternative binder is PTFE.

In an alternative arrangement, which is illustrated in FIG. 3, the particles 15 of said first material can be placed as a layer on a base of a tray 28′ or hollow vessel which is disposed with its base substantially horizontal in the electrochemical cell. The reference numerals used in the electrochemical cell in FIG. 3 are otherwise the same as used in the cell of FIG. 1 and the corresponding description applies. The main difference is that the electrodes 14 and 16 are arranged horizontally beneath the surface 18′ of the electrolyte rather than vertically as in FIG. 1.

Instead of providing the first material as a loose powder, which is possible with an arrangement as shown in FIG. 3, it is also possible to bind it into one or more pellets formed from a mixture of a powder and a binder. In this case the individual particles shown in FIG. 3 can be understood to be individual pellets. It is noted that the illustration of FIG. 3 is not intended to suggest that there are just two or three layers of powder or pellets, there can be many more. If pellets are used the base of the tray or hollow vessel can also be porous, with a pore size smaller than that of the pellets.

Some specific examples of the invention will now be given with reference to the further drawings.

The overall synthetic procedure is depicted in FIG. 4 which actually illustrates three basic possibilities. The first possibility, which is used in this example is the insertion of lithium into a solid metal oxide MOₓ with micron size particles to form a nanoporous composite M/Li₂O, involves the use of washing to, e.g. in dilute sulphuric acid to remove the Li₂O and leave nanoporous metal M. One example of this possibility is given as Example I below.

A second possibility is the use of current reversal to electrochemically remove the Li from the nanocomposite of M/Li₂O. This results in the renewed formation of the MOₓ which is now in nanoporous form. One example of this second possibility is the Example II.

The third possibility is to proceed as for the second possibility but to halt the LI₂O extraction so that only partial lithium extraction is achieved electrically and then to remove the remainder of the Li₂O chemically as for the first possibility. The result is a mixture of the metal M and the MOₓ in nanoporous form.

### EXAMPLE I

The first example is the synthesis of nanoporous Pt from sub-micrometre PtO₂ by electrochemical lithiation followed by dissolving the Li₂O in dilute acid solution at room temperature. The reaction equation is as follows:

4Li+PtO₂→Pt:2Li₂O (2)

The PtO₂ particles are bonded together by a PVDF binder and adhered by it to a Ni mesh as specified above. Equation 2 shows that in the electrochemical cell 10 of FIG. 1 lithium ions from the second, lithium electrode 16 move through the electrolyte (1 molar LiPF6: EC-DMC (1:1) Merck as quoted above) and enter the PtO₂ particles 15 present as the first material at the first electrode 14 where they react with the oxygen present in the platinum oxide to reduce it to the platinum metal, the first metal, while forming a compound of the second metal, i.e. lithium oxide, Li₂O. Thus, in this electrochemical lithiation process, 4 Li is inserted into the starting material of PtO₂, resulting in the formation of the Pt/Li₂O nanocomposite. This electrochemical insertion process termed discharging is illustrated in FIG. 5. The discharge curve 30 shows that at constant current the voltage across the electrochemical cell drops from 3.2 volts at the start of lithiation of the first material 15 (PtO₂) to 1.2 volts at the end of the lithiation process. The particle size of the initial PtO₂ is in the 0.15-0.30 μm range. On insertion of 4 Li, disintegration within the particle is observed resulting in nanograins of Pt of 2-8 nm as shown in FIG. 6. More specifically FIG. 6 shows individual grains such as 32 which are of crystralline form with a lattice constant of 0.226 nm, this being the distance between neighbouring 111 planes such as 33, 34. The SAED image 35 confirms the crystalline nature of the nanoparticles of Pt. The crystals have an fcc lattice. The inset 36 shows the HRTEM image to a smaller scale.

The particles of the Pt:2Li₂O nanocomposite are then subjected to washing in dilute sulphuric acid of 1 molar concentration. During washing the Pt:2Li₂O nanocomposite reacts with the hydrogen ions of the sulphuric acid according to the following equation:

Pt:2Li₂O+2H₂SO₄→Pt (nanoporous)+2Li₂SO₄+2H₂O (3)

The result of the washing is the nanoporous structure of Pt as shown in FIG. 7. The nanograins can be seen clearly, e.g. at 37 as can the grain boundaries at 38 and a pore at 39 in the main HRTEM image with the 5 nm scale bar. Pores of various sizes in the 2-20 nm range were formed. The SAED pattern at 35 again confirms the crystalline nature of the Pt nanograins. The crystalline Pt nanograins still remain together in an agglomerate having essentially the original particle shape or envelope but of larger volume. An overview image is shown at 36 to a smaller scale (30 nm scale bar). According to Brunauer-Emmett-Teller (BET) analysis, a total specific surface area of 142 m² g⁻¹ is obtained. Barrett-Joyner-Halenda (BJH) pore size distribution indicates that the Pt particles have various pore sizes in the range of 3-14 nm.

### EXAMPLE II

The second example is the synthesis of nanoporous RuO₂ from submicrometre RuO₂ particles by an electrochemical lithiation/delithiation process according to the equations:

4Li+RuO₂→Ru:2Li₂O (4)

Ru:2Li₂O→RuO₂ (nanoporous)+4Li (5)

The electrochemical cell of FIG. 1 is again used for this purpose. The first significant difference to Example I above is that the first material of the first electrode 14 now comprises RuO₂ particles in a PVDF binder on a Ni mesh support. Li is first introduced from the second Li electrode during a discharging process 42 illustrated in FIG. 8 in which the proportion x of Li in the LiₓRuO₂ composite increases to the maximum value of 4 during discharging from a cell voltage of 4.3 volts to a cell voltage of about 0.7 volts and with a maximum cell capacity of over 800 mAh/g. This generates a Ru/2Li₂O composite, which has a nanostructure, i.e. nanosized particles or grains of Ru interspersed with Li₂O. Then the switch 24 is moved to disconnect the cell from the constant current source 22 and connect it across the resistor 26 during a charging operation shown by 42 in FIG. 8. alternatively the current polarity can be reversed. This removes the lithium again to leave nano-structured porous ruthenium oxide as shown in FIG. 9. Again the individual nanograins can be seen at 32 and the lattice constant of the crystal lattice of the ruthenium dioxide is found to be 0.256 nm. The first electrode can then be removed from the cell 10 and the nanoporous ruthenium oxide can be used (after separating it from the support mesh 28 if necessary) for whatever application is intended. I.e. it forms the starting material for further processing or further use. Thus, in the electrochemical lithiation/delithiation process, 4 Li can be reversibly inserted and extracted into and out of RuO₂, resulting in the formation of Ru/Li₂O nanocomposite and nanocrystalline RuO₂, respectively. After electrochemical lithiation/delithiation, the HRTEM image (FIG. 9) reveals a disintegrated microstructure which is due to the irreversible volume expansion on Li insertion/extraction, in contrast to the intact single-crystal (30 nm-0.2 μm) in its initial stage. Disordered nanopores and nanograins of 2-8 nm within the microstructure can be clearly observed from the micrographs of FIG. 9. A measurement of the BET surface shows a total specific surface area of 239 m² g⁻¹. A BJH pore size distribution analysis indicates that the resulting RuO₂ exhibits various distinguished pore diameters of 3.8, 5.4, 8.2 and 16 nm. The HRTEM image of the sample after immersion into 1.0 M H₂SO₄ solution, as shown in FIG. 10 shows that it still retains its morphology and pore structure.

### EXAMPLE III

The third example is the synthesis of nanoporous RuO₂ from submicrometre RuO₂ by using Na as a non-parent metal according to the following reactions:

4Na+RuO₂→Ru:2Na₂O (6)

Ru:2Na₂O→RuO₂ (nanoporous)+4Na (7)

In the above electrochemical displacement reaction of equation (6) Na can be reversibly inserted and extracted into and out of RuO₂, resulting in the formation of Ru/Na₂O nanocomposite and nanocrystalline RuO₂, respectively. That is to say the first starting material 15 of the first electrode 14 comprises RuO₂ particles adhered together and to a Ni mesh 28 as described before in connection with example II. The second electrode comprises an Na foil and the electrolyte is 1M NaClO₄ in EC-DMC as described above. FIG. 11 shows the HRTEM image of the resulting nanostructured RuO₂.

### EXAMPLE IV

The electrocatalytic activity of nanoporous Pt prepared in accordance with Example I above for the oxidation of methanol was measured in an electrolyte of 1 M methanol in 0.5 M H₂SO₄ by using cyclic voltammograms (CVs). For clarity, only the cycles of 1, 10, 20, 30, 40, 50, 60, 70, 80, 90, and 100 are plotted in FIG. 12. The peak potential for the oxidation of methanol is approximately 0.68 V (vs. SCE). The peak current density of the first scan cycle for the nanoporous Pt with a Pt loading of 0.05 mg cm⁻² is up to 9.3 mA cm⁻² (i.e. the mass current density per unit mass of platinum is 186 mA mg⁻¹). Even after 100 scan cycles the peak current density is still as high as 8.0 mA cm⁻² (i.e. 160 mA mg⁻¹). This nanoporous Pt shows the highest catalytic activity observed for pure Pt mixed in a standard way with carbon as support. The experimental result reported here highlights the potential application of the nanoporous metallic Pt prepared by the electrochemical lithiation method as a highly efficient catalyst for DMFCs (direct methanol fuel cells).

### EXAMPLE V

Owing to the high surface area, the presence of various pore sizes and the pronounced stability of the nanoporous RuO₂ prepared in accordance with Example II this material is expected to exhibit excellent supercapacitive performance. The typical CVs recorded at different scan rates for the nanoporous RuO₂ electrode in 1.0 M H₂SO₄ solution are shown in FIG. 13. The mirror-like profile of the CV curves indicates a high reversibility. The specific capacitance was found to be ca. 385 F g⁻¹ at a scan rate of 1 mV s⁻¹ which is close to three hundred times larger than that of the starting RuO₂ (1.2 F g⁻¹). An excellent cycling performance at a scan rate of 5 mV s⁻¹ was also obtained for the nanoporous RuO₂.

### EXAMPLE VI

As noted above the invention can also be used with a first material comprising a compound of an alloy of first metals. In this example the first material is an oxide of an alloy of Pt and Ru in the form PtRuOₓ. Again micron sized particles of this material blended with graphite and carbon black are bonded together and to a mesh 28 of Ni to form a first electrode 14. Lithium insertion and removal then takes place in accordance with Example II to produce a nanoporous alloy of PtRu.

### EXAMPLES VII AND VIII

These examples correspond to Example II given above except that the first metal is selected to be Mg or Al instead of Li. In the case of Mg as the material of the second electrode the electrolyte is selected to be Mg(ClO₄)₂ in EC-DMC (Example VII). In the case of Al as the second electrode the electrolyte is selected to be Al(N(CF₃SO₂)₂)₃ in EC-DMC (Example VIII).

The Examples I, II, III, VI and VII to VIII can also be repeated using fluorides, sulphides, phosphides, nitrides or chlorides of the first metal instead of the oxides.

To date experiments have been conducted with the following compounds using lithium insertion and have been shown to produce the desired nanoporous material: PtO₂, RuO₂, RuS₂, Au₂O₃, IrO₂, TiF₃, VF₂, Cr₂O₃, CoO, FeO, Co₃O₄, CoTiO₃, CoF₃, NiO, NiF₂, CuO, Cu₂O, CuF₂, MnF₂, MnF₃, MoO₃, NbO, SnO₂, SnF₄, ZnO, ZnS and ZnF₂.

It should be noted that the first metal compounds of the first electrode materials can be crystalline or amorphous. A change in the microstructure sometimes accompanies the insertion of the second metal into the compound of the first metal.

The nanoporous materials prepared by one or more of the above methods can be used for catalysis. This particularly applies to the metals Pt, Ru, Ni, Mo, Pd, Ag, Ir, W and Au which are useful catalysts. E.g. a porous gold catalyst formed from gold oxide by a lithiation/delithiation process can be used in a fuel cell system or reformer to promote the following shift reaction

2CO+O₂→2CO₂ (8)

Pt in particular is useful for the electro-oxidation of methanol in a direct methanol fuel cell, or in a reformer or as an electrode in a fuel cell.

The nanoporous materials prepared by one or more of the preceding methods can also be useful as an electrode material in a supercapacitor. This particularly applies to the compounds of Ru but also to those of Mo, Au, Pt, Cr, Mn, Ni, Fe or Co.

The nanoporous materials prepared by one or more of the above methods are also useful as a sensor. E.g. Fe₂O₃ is useful as an ethanol sensor.

All of the nanoporous materials can find use in membranes for diverse purposes such as ultrafiltration or separation processes.

Moreover, the nanoporous materials can also serve as a support for other materials such as materials deposited galvanically, or by immersion or by a CVD or PVD process on them.

### EXAMPLE IX

It has surprisingly been found that the method of the present invention can also be used to synthesize nanoporous carbon with highly ordered graphitic structure at room temperature. This can be done, i.e. the nanoporous carbon can be synthesized according to the following reaction:

1.1Li+CF_{1.1}→C:1.1LiF (1)

C:1.1LiF+xH₂O→C (nanoporous)+1.1 LiF [symbol] xH₂O (2)

It can be concluded from XRD, Raman and HRTEM (FIGS. 14, 15, 17 and 18) that the samples show a typical nanoporous carbon structure after lithiation (FIG. 16) and washing to remove the LiF. It can be observed that after lithiation and washing, the particles retain the morphology (FIGS. 17a and 18a).

The nanoporous carbon shows good capacitive performance when used as an electrode material in a supercapacitor. The CVs recorded at a scan rate of 5 mV s⁻¹ for the nanoporous carbon electrode in 1.0 M H₂SO₄ solution are presented in FIG. 19a. The profile of the CV curves indicates a high reversibility. To determine the specific capacitance, galvanostatic discharge/charge measurements were carried out at different current densities, whose results are shown in FIG. 19b. The specific capacitance was found to be ca. 79 F g⁻¹ at a current of 0.2 mA. At higher currents of 0.3 and 0.4 mA, capacitance values of ca. 58 and 52 F g⁻¹ were obtained. The nanoporous carbon shows a good supercapacitive performance.

This nanoporous carbon with highly ordered graphitic structure can also be used in some electrocatalysis reactions or used as a support in electrochemical devices.

The electrochemical lithiation experiments were performed using two-electrode Swagelok-type™ cell. For preparing working electrodes, a mixture of C_{1.1} (Aldrich) and poly (vinyl difluoride) (PVDF) at a weight ratio of 90:10, was pasted on pure Cu foil. Experiments for electrocatalytic and supercapacitive performances were conducted on the electrode composed of C and PVDF (90:10). Pure lithium foil (Aldrich) was used as counter electrode. The electrolyte consists of a solution of 1 M LiPF₆ in ethylene carbonate (EC)/dimethyl carbonate (DMC) (1:1 by volume) obtained from Ube Industries Ltd. The cell was assembled into a three-layered structure (C, glass fiber and lithium foil) in an argon-filled glove box. Discharge test at a rate of C/50 was carried out on an Arbin MSTAT system. Prior to the following measurements, the samples were washed by DMC and NMP in air to remove the residual electrolyte and PVDF, respectively. Then, the sample was further washed by 0.5 M HNO₃ aqueous solution to remove the LiF at 80° C. XRD measurements were carried out with a PHILIPS PW3710 using filtered Cu K [symbol] radiation. Micro-Raman spectra were recorded on a Jobin Yvon LabRam spectrometer using a 632.8 nm excitation laser line. HRTEM was performed on a JEOL 4000EX transmission electron microscope, operating at 400 kV. The nitrogen sorption isotherms were obtained with an Autosorb-1 system (Quanta Chrome); the sample after electrochemical lithiation and washing was outgassed overnight at 150° C. before the measurements.

Experiments for electrocatalytic and supercapacitive performances were conducted on the electrode composed of C and PVDF (90:10). Electrocatalytic and supercapacitive performances were characterized with a three-electrode configuration, where a platinum foil, saturated calomel electrode (SCE) and C electrode were used as counter, reference and working electrodes, respectively. The used electrolyte was 1.0 M H₂SO₄ aqueous solution for supercapacitor. Cyclic voltammograms were carried out on a Solartron SI 1287 electrochemical interface.

It seems that the method of the invention could also be applied to other non-metallic materials than carbon and that the second metal could be chosen from the group including Li, Na, K, Cs, Mg, Ca and Al.

1-18. (canceled)

19. A method for the preparation of materials comprising the steps of:
a) taking a first material (15) comprising a compound of a first metal or of a first metal alloy,
b) inserting said first material (15) into an electrochemical cell (10) as a first electrode (14), the electrochemical cell including a second electrode (16) including a second metal different from a metal incorporated in the first material and an electrolyte (18) adapted to transport the second metal to the first electrode and insert it into the first material by a current flowing in an external circuit (20) resulting in the formation of a compound of the second metal in the first electrode material (15), and
c) treating the first electrode material (15) after formation of the compound of the second metal to chemically and/or electrochemically remove at least some of the compound of the second metal to leave a material with a nanoporous structure.

20. A method in accordance with claim 19 wherein the first metal is selected from the group comprising Pt, Ru, Au, Ir, Ti, V, Cr, Mn, Fe, Co, Ni, Cu, Zn, Zr, Nb, Mo, Rh, Pd, Ag, Cd, In, Sn, Sb, Hf, Ta, W, Re, Os, Tl, Pb and Bi and an alloy of any of the foregoing, wherein the first material comprises an oxide, sulphide, fluoride, chloride, nitride or phosphide compound of one of the first metals or of an alloy thereof and wherein said second metal is selected from the group including Li, Na, K, Cs, Mg, Ca and Al.

21. A method in accordance with claim 19 wherein, in step c), the treatment of the first selected material (15) after formation of the compound of the second metal to chemically remove at least some of it is effected by one of the following chemicals water, dilute sulphuric acid, 0.1 to 1.0 molar sulphuric acid, concentrated sulphuric acid, 0.1 to 1.0 molar HCl, and HNO₃ and is selected so that it can dissolve the compound of the second metal and it does not chemically react with the first metal or first metal compound.

22. A method in accordance with claim 19 wherein, prior to step c), the direction of current flow in the electrochemical cell (10) is reversed to at least partially reduce the second metal compound to the second metal and at least partially remove the second metal from the first electrode material.

23. A method in accordance with claim 22 wherein the step of reversing the direction of current flowing in the electrochemical cell is effected until a maximum potential difference is achieved between the first electrode and the second electrode typical for the second metal prior to degradation of the electrolyte; for example, with the maximum potential for lithium as the second metal being 4.3 volts and that for Na as the second metal being 4.0 volts.

24. A method in accordance with claim 19 wherein the nanoporous material prepared by the method is a mixture of a compound of a first metal and a first metal which is present in the form of a porous nanostructure.

25. A method in accordance with claim 19 and comprising a further step of exposing the nanostructure to an energy field such as an ultrasonic field to split the nanostructure into particles.

26. A method in accordance with claim 19 wherein the first material is selected in the form of particles having a size in the range from 50 μm to 100 nm, preferably in the range from 5 μm to 200 nm and especially in the range from 1 μm to 300 nm and in that, after step c), the material having a nanoporous structure includes particles having the same morphology, i.e. essentially the same shape or envelope as the original particles but with the nanoporous structure.

27. A method in accordance with claim 19 wherein the first electrode comprises a powder mixed with a binder and applied to a substrate, e.g. a substrate comprises a metallic foil or mesh (28) selected from the group comprising Cu, Ti, Ni and stainless steel.

28. A method in accordance with claim 19 and including the step of bonding the particles of the first material (15) together and to a porous conductive carrier using one or more binders.

29. A method in accordance with claim 19 including preparing a first material (15) as a mixture of a compound of a first metal of a first metal alloy with one or more other conductive powders, e.g. carbon black and/or graphite.

30. A method in accordance with claim 19 wherein the first material (15) is present in the form of a film or of particles bound together by a binder to form a film.

31. A method in accordance with claim 19 wherein said particles of said first material are placed as a layer on a base of a tray or hollow vessel (28′) which is disposed with its base substantially horizontal in the electrolytic cell.

32. A method in accordance with claim 19 wherein the first material (15) comprises one or more pellets formed from a mixture of a powder and a binder.

33. Use of the nanoporous material prepared by the method of claim 19 for one of the following applications:
for catalysis,
as a catalyst, e.g. in the form of at least one of nanoporous Pt, Ru, Ni, Mo, Pd, Ag, Ir, W and Au,
for the electro-oxidation of methanol in a direct methanol fuel cell, or in a reformer or as an electrode in a fuel cell,
as a component of a supercapacitor, e.g. as a compound based on Ru, Mo, Au, Pt, Cr, Mn, Fe, Co or Ni,
as a sensor,
as a membrane,
or as a carrier or support for another material, for example a material deposited galvanically or by immersion on the nanoporous material as a carrier or support.

34. A method for the preparation of nanoporous carbon comprising the steps of:
a) taking a first material (15) comprising a compound of carbon,
b) inserting said first material (15) into an electrochemical cell (10) as a first electrode (14), the electrochemical cell including a second electrode (16) including a metal selected from the group including Li, Na, K, Cs, Mg, Ca and Al an electrolyte (18) adapted to transport the metal to the first electrode and insert it into the first material by a current flowing in an external circuit (20) resulting in the formation of a compound of the second metal in the first electrode material (15) and
c) treating the first electrode material (15) after formation of the compound of the second metal to chemically and/or electrochemically remove at least some of the compound of the second metal to leave carbon material with a nanoporous structure.

35. A method in accordance with claim 34 wherein the carbon compound is CF_{1.1}, the second metal is Li and the electrolyte is 1 M LiPF₆ in EC/DMC (1:1 by volume).

36. Use of the nanoporous material prepared by the method of claim 34 for one of the following applications:
for catalysis,
as a catalyst, e.g. in the form of at least one of nanoporous Pt, Ru, Ni, Mo, Pd, Ag, Ir, W and Au,
for the electro-oxidation of methanol in a direct methanol fuel cell, or in a reformer or as an electrode in a fuel cell,
as a component of a supercapacitor, e.g. as a compound based on Ru, Mo, Au, Pt, Cr, Mn, Fe, Co or Ni,
as a sensor,
as a membrane,
or as a carrier or support for another material, for example a material deposited galvanically or by immersion on the nanoporous material as a carrier or support.
